(19) United States
(12) Patent Application Publication
(10) Pub. No.: US 2018/0056551 A1
(43) Pub. Date: Mar. 1, 2018

(54) INDUCTIVE HEATING OF CASTING MOLDS

(71) Applicant: Weckerle GmbH, Weilheim (DE)

(72) Inventor: Sven Droste, Peibenberg (DE)

(21) Appl. No.: 15/691,274

(22) Filed: Aug. 30, 2017

(30) Foreign Application Priority Data
Aug. 31, 2016 (EP) 16186552.2

(51) Int. Cl. B29C 39/38

(52) U.S. Cl. CPC B29C 39/38; B29K 2091/00

(57) ABSTRACT

A method and a system for heating of a casting mold, in particular for heating of casting molds for cosmetic products, is described. The system comprises at least an inductor for generating of at least one alternating magnetic field and at least one casting mold, wherein the casting mold consists substantially of a plastic material or an elastomer and is permeated with at least one additive, wherein the additive may be inductively heated.

### PRIOR APPLICATIONS

The present application claims priority to European Patent Application No. 16186552.2 filed Aug. 31, 2016, the contents of which are included herein by reference.

### TECHNICAL FIELD

The present invention relates generally to the inductive heating of casting molds for cosmetic products, in particular the inductive heating of casting molds made of an elastomer or of a plastic material.

### BACKGROUND

In the production of cosmetic products, casting molds are used, for example, to receive a heated and flowable mixture of different waxes and additives, wherein the mixture may be referred to as a pasty mass. The pasty mass is filled into the casting molds in order to take its shape. A casting mold can, for example, be used for shaping lipstick mines. The shape of the lipstick mine corresponds to the inner contour of the casting mold into which the pasty mass has been filled and in which the latter has been cooled and solidified. In this case, the cooling may take place actively, i.e. by applying cooling, or passively, without applying cooling. In order to achieve the smoothest possible surface of the lipstick mine, a premature cooling and solidification of the part of the pasty mass which comes into direct contact with the inner contour of the casting mold must be prevented during the filling process. For this purpose, the casting molds are brought to an elevated temperature level before filling with the pasty mass, that is, the casting molds are heated or respectively preheated, which prevents premature solidification at least of the part of the pasty mass which comes into direct contact with the inner contour of the casting mold. Premature cooling and solidification of the pasty mass may otherwise lead to the formation of cracks, pores and imperfections on the surface of the later product, for example of the lipstick mines. In order to counteract these quality losses, the casting molds are heated before and/or during the casting process.

Different methods and devices are known in the prior art by ease of which casting molds may be heated in order to prevent premature cooling and solidification of the pasty mass when they are filled with a pasty mass.

For example, EP 0 712 593 A1 describes the fact that casting molds are heated by bathing them with tempered water.

However, this has the disadvantage that a heat introduction into the casting molds takes place only indirectly, i.e. through the heat carrier water. In particular in the case of casting molds, which consist of materials which are poorly thermally conductive, such as plastic materials or elastomers, this leads to long delays in the process cycle. Furthermore, a uniform heat introduction may not be guaranteed. In addition, in systems of this kind, it is usually possible to have direct contact between the heat carrier medium and the casting molds. This may lead to the casting molds becoming worn out prematurely or other deposits forming of the casting molds which may adversely affect the production of the cosmetic products.

It is therefore an object of the present invention to provide a method, a casting mold and a system which do not have the above-mentioned disadvantages. In particular, with the method and the system, a targeted preheating of the casting molds shall be possible, even if these consist of a material which is poorly thermally conductive.

### SUMMARY

This object is achieved by the method, the casting mold and the system of the independent claims. Advantageous embodiments are described in the dependent claims.

The method according to the invention for the inductively heating of casting molds, in particular for the inductive heating of casting molds for cosmetic products, comprises the generating of at least one alternating magnetic field by ease of at least one inductor and the inductively heating of at least one casting mold, wherein the at least one casting mold consists substantially of a plastic material or elastomer and is permeated with at least one additive, wherein the at least one additive can be heated inductively. Because the casting mold substantially consists of a plastic material or elastomer, the casting mold may be at least partially flexible.

Inductive heating is based on the fact that an alternating current streams through the at least one inductor, which at least produces a magnetic field around the at least one inductor. The magnetic field, in turn, induces eddy currents which are directly converted into heat in the additive with which the casting mold is permeated, the heat being delivered to the material surrounding the additive. Because of this, this material is also heated or warmed up. The additive in the casting mold is thus heated inductively and produces a heat introduction into the material of the casting mold surrounding the additive. It may therefore be said that the additive is directly heated, while the material of the casting mold is heated indirectly. The temperature at which the casting mold is heated depends on the strength of the generated eddy currents, among others. The magnitude of the eddy currents is dependent on the distance between the inductor and the surface of the casting mold facing the inductor, as well as on the magnitude of the alternating current, which flows through at least one inductor. The temperature may be regulated, for example, via the aforementioned factors such that there is no damage to the material due to overheating, but a targeted heat introduction into the casting mold is made possible.

The method according to the invention provides for the first time a method with which a targeted heating of casting molds for cosmetic products is possible, i.e. a method in which the heating of the casting mold takes place as quickly and purposefully as possible and a cycle time which is as short as possible may be achieved in the production of cosmetic products. Furthermore, such a method may also be carried out almost without contact.

In a preferred embodiment of the method according to the invention, the at least one magnetic field, produced by the at least one inductor, is regulated. The magnetic field is composed of magnetic field lines which extend around the inductor on closed paths. The magnetic field may be quantified over the two physical quantities magnetic field strength and magnetic flux density. The control of the magnetic field may thus take place, for example, by controlling the magnetic field strength and the magnetic flux density. The magnetic field strength and the magnetic flux density may be controlled by the geometry of the inductor itself, but may also be controlled by the alternating current that flows through the inductor. The regulation of the at least one magnetic field may include regulating the strength of the alternating current. The strength of the alternating current flowing through the inductor is proportional to the strength of the generated magnetic field strength and the magnetic flux density. The magnetic flux density corresponds to the magnetic field strength multiplied by the magnetic field constant and the permeability number. The periodic change of the current causes a periodic change of the magnetic field produced by the inductor. Due to the periodic change of the magnetic field, the magnetic field may also be referred to as an alternating magnetic field. By controlling the strength of the alternating current, the intensity of the induced eddy currents may be influenced, whereby the degree of the heat introduction may be controlled. The heating of the casting mold may thus be controlled. In this case, the stronger are the alternating current flowing through the inductor, the stronger the generated eddy currents and the greater is the occurring heat introduction. For example, the strength of the alternating current may be in the range between 50 A and 400 A.

Additionally or alternatively to the control of the strength of the alternating current, which flows through at the least one inductor, the frequency of the alternating current may also be regulated. The frequency of the alternating current, which flows through the at least one inductor according to the invention, specifies the frequency with which the alternating magnetic field changes direction. In general, the frequency of an alternating magnetic field during inductive heating has an influence on the distribution of the current density from the eddy currents induced by the alternating magnetic field in the to be heated additive of the casting mold. For example, the greatest current density of the induced eddy currents in the at least one casting mold may also occur at its surface facing the inductor and may decrease with increasing distance. The penetration depth of the induced eddy currents depends on the frequency of the alternating current, which flows through the inductor. The higher the frequency, the lower is the penetration depth of the induced eddy currents. The penetration depth of the induced eddy currents may thus be determined via the frequency of the alternating current flowing through the inductor. In case the inductor surrounds the casting mold at partially, the frequency may be regulated such that the penetration depth of the induced eddy currents is adjusted in such a way that the eddy currents initially heat a region of the casting mold which faces the inductor and the frequency may subsequently be reduced in such a way that the penetration depth of the induced eddy currents is adjusted in such a way that a region of the casting mold, which is further spaced apart from the inductor, is heated. For example, the frequency of the alternating current may be in the range between 50 Hz and 450 kHz.

By regulating the strength of the alternating current and its frequency, the heat introduction into the casting mold may thus be regulated and a targeted heat profile may be generated. The generated heat profile may be adapted to the properties of the pasty mass, which is filled into the casting mold. The thermal profile may thus be matched to the waxes and additives, which make up the paste mass, and may be adapted such that the pasty mass may solidify specifically in the casting mold. Thereby, it may for example also be advantageous if the inductor also generates eddy currents during the filling and/or after the filling of the casting mold, their strength and penetration depth, however, decreases with the time lapsed, such that the pasty mass in the casting mold cools specifically and solidifies specifically.

In a further preferred embodiment of the method according to the invention, the method comprises adjusting a distance between the at least one inductor and the at least one casting mold. Via the distance between the inductor and the casting mold, the area density of the magnetic field lines of the alternating magnetic field generated by the inductor may be regulated, with which the alternating magnetic field penetrates the casting mold. The heat introduction may also be controlled by the distance. The degree of the heat introduction or the induced eddy currents is proportional to the area density of the magnetic field lines, which penetrate the casting mold, and thus has a proportional effect on the degree of heating of the casting mold. Thus, by adjusting the distance between the inductor and the casting mold, the degree of heating of the at least one casting mold may be controlled. It may also be said that with the adjustment of the distance between the inductor and the casting mold, the efficiency of the inductive heating may be regulated. The distance between the inductor and the casting mold may thereby be adjusted by a movement of the inductor and/or of the casting mold.

In a further preferred embodiment of the method according to the invention, the method comprises determining a temperature of the at least one casting mold to be heated and controlling the inductive heating of the at least one casting mold based on the determined temperature. With the inductive heating of the at least one casting mold, the casting mold is brought to an elevated temperature level prior to the filling with the pasty mass according to the invention. The elevated temperature level of the casting mold is thereby selected in such a way that the pasty mass maintains a flowable state during the entire filling process. In particular, by the increased temperature level of the casting mold, the pasty mass should maintain a flowable state at its edges, i.e. where it is in direct contact with the wall of the casting mold, during the entire filling process. The temperature of the at least one casting mold can, for example, be determined before the start of the inductive heating and represents an actual value of the temperature of the casting mold before the start of the filling process. The actual value may be compared with a desired value of the temperature of the at least one casting mold, i.e. the elevated temperature level of the casting mold before the start of the filling process. From the difference between the actual value and the desired value of the temperature value of the at least one casting mold, the degree of heating which is necessary in order to inductively heat the casting mold to the desired nominal temperature may be determined. The temperature may be determined during the inductive heating of the casting mold at regular intervals. The desired value of the temperature of the at least one casting mold may be an upper threshold, and the inductive heating of the at least one casting mold may be controlled in such a way that the inductive heating of the at least one casting mold is terminated as soon as the temperature of the casting mold exceeds the upper threshold. The desired temperature of the casting mold can, for example, also be set before the beginning of the filling process to a range which may be referred to as an upper temperature range and which is limited by an upper and a lower threshold. The inductive heating of the at least one casting mold may be controlled in such a way that the inductive heating of the at least one casting mold is interrupted as soon as the temperature of the casting mold exceeds the upper threshold and that the inductive heating of the at least one casting mold is continued, if the temperature of the casting mold falls below the lower threshold. The alternation between interruption and continuation of the inductive heating may be repeated as desired and/or as long as it seems reasonable. For example, the alternation between interruption and continuation of the inductive heating may still take place during the filling process. The person skilled in the art is aware that the alternation between interruption and continuation of the inductive heating may be referred to as a regulation circuit. This regulation circuit may be represented as a oscillating circuit, and the person skilled in the art is able to adjust the parameters of the various components in the oscillating circuit such that a stable regulation of the temperature of the at least one casting mold is made possible. The temperature of the at least one casting mold may be regulated in this case in such a way that different regions of the casting mold are heated differently. For example, during the filling process, the temperature may be reduced in a lower region of the casting mold, which is already filled with the pasty mass, while a higher temperature level is maintained in an upper region of the casting mold in which the casting mold is just filled with the pasty mass. According to the invention, the temperature may be determined on the inner surface, i.e. the inner contour, of at least one casting mold, but also the temperature may be determined on the outer surface, i.e. the outer contour, of at least one casting mold. For example, the temperature may be determined inside of the at least one casting mold in order to disturb the filling process during the determination of the temperature as less as possible. The degree of heating may be influenced by regulating the parameters described above in such a way that the at least one casting mold may be heated as quickly and specifically as possible without the material being damaged by overheating, wherein the material may be the material, of which the at least one casting mold substantially consists, but also the material of the waxes and additives of which the pasty mass consists. Other parameters are known to the person skilled in the art, by ease of which the degree of heating may be influenced, for example by the selection of the material of the inductor.

The above-mentioned object is also achieved by a casting mold according to the invention, in particular a casting mold for shaping cosmetic products, which consists substantially of a plastic material or elastomer and which is at least permeated with an additive, the additive may be inductively heated. Because the casting mold consists substantially of a plastic material or elastomer, it may be at least partially flexible. The at least one additive can, for example, be added in the form of particles to the material from which the casting mold is formed. The plastic material or the elastomer of the casting mold and the additive may form a heterogeneous mixture of substances. It may be said that the heterogeneous mixture of substances is a dispersion, wherein the additive in the casting mold forms a disperse phase and the plastic material or the elastomer in the casting mold forms a dispersion medium. The dispersion medium adds, for example, flexibility and a smooth surface to the casting mold, and the disperse phase reacts, for example, to the induced alternating magnetic field and allows the casting mold to be able to be heated inductively. On account of the heat transfer, the produced heat is transferred from the disperse phase to the dispersion medium during the inductive heating of the casting mold, and thus the casting mold is heated. It may also be said that the disperse phase is heated directly, while the dispersion medium is heated indirectly. The proportion of the disperse phase in the dispersion may vary, for example, depending on the specific heat capacities and the thermal conductivities of the materials used. As a rule, the disperse phase has a lower specific heat capacity and a higher coefficient of thermal conductivity than the dispersion medium, i.e. the disperse phase may be quickly heated to a high temperature level, but the generated heat may not be stored for long. If the inductively heated casting mold is to be able to maintain its once attained high temperature level after an interruption of the inductive heating for a long period of time, a low proportion of the disperse phase is advantageous in the dispersion, i.e. in the structure of the casting mold. The proportion of the disperse phase may thus be so low that it may be said that the casting mold substantially consists of the dispersion medium, i.e. the plastic material or the elastomer. For example, the dispersion may be designed such that the disperse phase in the dispersion has a mass fraction of up to 10%.

If, on the other hand, for example, rapid heating of the casting mold to a high temperature level is to be made possible, wherein the casting mold cools rapidly after an interruption of the inductive heating, a high proportion of the disperse phase is advantageous. The proportion of the disperse phase may thus be so high that it may also be said that the casting mold is partly made from the dispersion medium, i.e. a plastic material or elastomer, and partly from the disperse phase.

As described above, the disperse phase consists mostly of particles which may be inductively heatable, i.e. may be heated. In this case, the particles may for example be uniformly distributed in the casting mold. From the uniform distribution of the particles, uniform thermal conductivity and uniform specific heat capacity of the casting mold may be assumed, and the degree of inductive heating of the casting mold may be regulated by the already described parameters. However, the particles may also be distributed unevenly, which may result, for example, in an accumulation of the particles in certain regions. Due to the accumulation of the particles in certain areas in the casting mold, the high thermal conductivity and the low specific heat capacity of the particles may be used, for example, in such a way that a control of the heat flow may take place through the casting mold or else along its surface. For example, a high degree of inductive heating of the casting mold may be concentrated in the specific region due to the accumulation of the particles in a certain region of the casting mold, whereas a low degree of inductive heating of the casting mold may take place in another region of the casting mold. In the case of the inductive heating of the casting mold, it is particularly necessary to heat the surface of the casting mold which comes into contact with the pasty mass, i.e. the inner contour of the casting mold. For the most effective inductive heating of the inner contour of the casting mold which is the inner surface of the casting mold, the particles may be concentrated, for example, in the region of the inner surface of the casting mold in order to heat this region of the casting mold specifically. The area of the inner surface of the casting mold may be, for example, a region which extends into the casting mold from the inner surface of the casting mold up to half the thickness of the casting mold. The particles may have a certain size, which may be referred to as a particle size, the particle size being, for example, chosen depending on the method by which the particles are introduced into the dispersion medium. The particle size may, for example, be adapted to the mechanical properties of the casting mold. For example, the particle size may be adapted to the required flexibility of the casting mold. The particle size may, for example, also be adapted to the desired surface configuration of the casting mold. For example, the particle size may be adapted to provide a smooth surface of the casting mold. Other parameters are known to the person skilled in the art, to which the particle size of the disperse phase in the dispersion medium may be adapted. The particles in the casting mold may have, for example, a particle size between 40 μm (0.0016 inch) and 400 μm (0.016 inch). The distribution of the at least one additive in the form of particles in the casting mold takes place during the production of the casting mold. The process by which the particles are introduced into the casting mold in this case may be referred to as seeding. The particles which form the at least one additive and the plastic material or the elastomer are mixed with one another. This is possible because the at least one additive does not, for example, form a chemical bond with the plastic material or the elastomer and does not participate in the crosslinking. The additive and the plastic material or the elastomer must therefore only be homogeneously mixed.

In a preferred embodiment of the casting mold according to the invention, the plastic material is a plastic material from the group of thermoplastically processable elastomers (TPE) and the elastomer is an elastomer from the group of thermal vulcanized silicone rubbers, such as RVTs (room temperature vulcanized rubber) or HTVs (high temperature vulcanized rubber). The elastomer may also be an elastomer from the group of LSRs (liquid silicone rubber).

In a preferred embodiment of the casting mold according to the invention, the at least one additive is an additive from the group consisting of a ferromagnetic material such as, for example, “MagSilica” from “Evonik”. Furthermore, one skilled in the art is aware that other additives may also be used, which result in a corresponding inductive heating. For example, metal powders, which preferably have an Fe content >50%, as are known, for example, from the powder metallurgical injection molding technique, may be used. The additives may, for example, comprise alloying constituents of carbon, silicon, chromium, molybdenum, cobalt and tungsten.

The above-mentioned object is also solved by a system for heating of casting molds, in particular for heating of casting molds for cosmetic products. The system according to the invention has at least one inductor for producing at least one alternating magnetic field and at least one casting mold, wherein the casting mold substantially consists of a plastic material or elastomer and is at least permeated with an additive, wherein the additive may be heated inductively. For example, the system may be designed in such a way that each inductor and each casting mold is a component of the system, and that each inductor generates an alternating magnetic field, each alternating magnetic field penetrating a casting mold for inductive heating. The person skilled in the art is aware that other arrangements of the components in the system are also possible in order to expose the casting molds to an alternating magnetic field for inductive heating. For example, several molds may be penetrated by the same alternating magnetic field.

In a preferred embodiment, the system comprises a means for regulating the strength of the alternating current and/or for regulating the frequency of the alternating current, which flows through the at least one inductor for generating the alternating magnetic field. For regulating the strength of the alternating current and thus for the power regulation of the inductor, through which the alternating current flows, for example, alternating current regulators equipped with thyristors may be used. These electronic components may be used in low, medium and high power ranges. For the regulation of the frequency of the alternating current, frequency converters, for example, may be used which generate an alternating voltage which may be regulated in frequency and in the amplitude. For example, frequency converters which have inputs for sensor signals and by which the generated alternating voltage is dependent on the frequency and the amplitude and wherein the generated frequency and amplitude of the alternating voltage is dependent upon the incoming sensor signals or a corresponding control. The at least one inductor may be configured in such a way that it comprises at least one cavity in its inside into which a cooling medium may penetrate. For example, the cooling medium may be conveyed through the at least one cavity of the at least one inductor, in that it is forcibly introduced, for example with a pump. The cooling medium may, for example, be water. The person skilled in the art is aware that, for the supply of at least one inductor, medium-frequency and/or high-frequency generators may be used which may supply the electrical power necessary for inductive heating over a wide frequency range. The strength of the alternating current and the frequency of the alternating current may thus be detected and adapted by a control oscillator in such a way that an efficiency optimum is achieved. This means that as much of the electrical energy as possible may be converted into heat energy. For example, medium-frequency and/or high-frequency generators, such as the TruHeat HF 3010 from Trumpf Hüttinger, may be used for this purpose.

In a preferred embodiment of the system according to the invention, the strength of the alternating current, which flows through the at least one inductor, is set in the range from 50 A to 400 A and the frequency of the alternating current, which flows through the at least one inductor, is in the range of 50 Hz to 450 kHz.

In a further preferred embodiment, the system comprises a means for adjusting the distance between the at least one inductor and the at least one casting mold.

The distance between the inductor and the casting mold may be determined by ease of optical measuring methods. In particular, the distance between the inductor and the surface of the casting mold facing the inductor is to be determined. The optical measuring method thus permits a non-contact measurement of the distance between the inductor and the surface facing the inductor without disturbing intervention in the process of inductive heating. An optical measuring method may, for example, be provided with the use of a laser operating according to the triangulation principle with which the distance between the inductor and the surface of the casting mold facing the inductor may be determined from a relatively large distance. The laser emits rays which are reflected on the surface of the inductor and on the surface of the casting mold facing the inductor, and are then received by an optical sensor. Alternatively or additionally to the optical measurement method, the at least one inductor may, for example, comprise at least one structural element which is coupled to the movement of the at least one inductor, and the at least one casting mold may comprise at least one structural element which is coupled to the movement of the at least one casting mold, and the distance between the at least one inductor and the surface of the at least one casting mold facing the inductor may be derived, for example, from the distance of the structural elements. In this case, for example, simple contact sensors may be used to detect the distance between the structural elements. Alternatively, inductive sensors or capacitive sensors may also be used for this purpose. The person skilled in the art will appreciate that other sensors may also be used to detect the distance between the structural elements which are coupled to the movement of the at least one inductor and to the movement of the at least one casting mold.

The distance between the at least one inductor and the surface of the at least one casting mold facing the inductor may be adjusted by ease of a relative movement of the inductor and of the casting mold. The inductor and the casting mold may be arranged such that the surface of the casting mold facing the inductor is the outer surface of the casting mold. In this case, in order to adjust the distance between the inductor and the surface of the casting mold facing the inductor, the inductor and the casting mold move relatively to each another in such a way that the inductor surrounds the casting mold. The inductor may, for example, be a so-called internal field inductor, which is shaped like a coil, in which the highest magnetic flux density of the induced alternating magnetic field occurs inside the coil. The relative movement may be caused, for example, by the fact that the inductor is guided by ease of a lifting mechanism to the casting mold in such a way that it surrounds the latter. Alternatively, the casting mold may also be moved by ease of a lifting mechanism such that it is enclosed by the inductor. For example, the relative movement of the inductor and of the casting mold may be generated by a simultaneous or time-offset movement of the inductor and of the casting mold. However, the inductor and the surface of the casting mold facing the inductor may also be arranged such that the surface of the casting mold facing the inductor is the inner surface of the casting mold. In this case, in order to adjust the distance between the inductor and the surface of the casting mold facing the inductor, both move relatively to one another in such a way that the inductor dips into the casting mold. The inductor may be, for example, a so-called external field inductor in which the highest magnetic flux density of the induced alternating magnetic field occurs outside the inductor. The relative movement may in this case be caused, for example, by the inductor being guided by ease of a lifting mechanism to the casting mold in such a way that it dips into the casting mold. Alternatively, the casting mold may also be moved by ease of a lifting mechanism so as to surround the inductor. For example, the relative movement of the inductor and of the casting mold may also be produced by a simultaneous or time-offset movement of the inductor and of the casting mold. For example, the at least one inductor and/or the at least one casting mold may also be mounted on at least one structural element in each case, and the structural element may be set in motion by a lifting mechanism. The movement of the structural elements may be adapted in such a way that it follows a clocking, the clocking representing a division of successive work cycles into time frames.

A work cycle may, for example, be divided into three time frames. In a first time frame of the work cycle at least one structural element may be moved such that the at least one structural element reaches a position in which the at least one casting mold may be inductively heated by the at least one inductor. Subsequently, in a second time frame of the work cycle, the at least one casting mold may be inductively heated. In a third time frame of the work cycle, the at least one structural element may be moved such that the at least one casting mold and the at least one inductor move away from each other so that a further casting mold may be moved to the inductor in a subsequent work cycle. This may be referred to as a further clocking of the structural element. The person skilled in the art is aware that the described movements represent relative movements of the at least one structural element and the at least one inductor, and that these relative motions may, for example, also be carried out by moving only the at least one inductor while the at least one structural element is not moved. The relative movements can, however, also be carried out, for example, by moving both, the at least one inductor and the at least one structural element. The person skilled in the art is aware that, in addition to the movement of the at least one structural element, the movement of the at least one lifting mechanism, with which the at least one inductor and/or the at least one casting mold and/or the at least one structural element may be set in motion, may be clocked. The at least one lifting mechanism which sets the at least one inductor and/or the at least at least one casting mold and/or the at least one structural element in motion, may be driven, for example, by at least one stepping motor. In this case, a stepping motor is a multiphase synchronous motor, which is pulse-controlled by ease of an electronic circuit. In the case of a pulsed drive, the motor shaft carries out a rotation about a specific angle of rotation, the so-called step angle. The means which sets the at least one lifting mechanism in motion may also be a servomotor. A servomotor is an electric motor, which may control the angular position and the rotational speed of the motor shaft, via a sensor for the position determination. The means by which the at least one inductor and/or the at least one casting mold and/or the at least one structural element are set in motion, responds to the sensor signals which indicate the distance between the inductor and the surfaces of the casting mold facing the inductor. Other means are known to a person skilled in the art for setting the at least one inductor and/or the at least one casting mold and/or the at least one structural element in motion and for adjusting a certain distance between the at least one inductor and the surface of the at least one casting mold facing the inductor. For example, hydraulic or pneumatic actuators may also be used for this purpose.

In a preferred embodiment, the system comprises a means for determining a temperature from the at least one casting mold and a means for controlling the at least one inductor based on the determined temperature. The temperature of the casting mold may, for example, be determined with at least one pyrometer which measures the heat radiation contactless which is emitted from the surface of the casting mold and determines the temperature of the surface of the casting mold from the measured heat radiation by ease of a known degree of emission from the surface of the casting mold. The surface of the casting mold whose temperature is determined may be, for example, the inner surface of the casting mold. The surface of the casting mold whose temperature is determined may also be the outer surface of the casting mold. In the course of a measurement, the pyrometer detects a specific area on the surface of the casting mold, which may be referred to as a measuring surface, wherein the measuring surface being generally smaller than the surface of the casting mold. According to the invention, the pyrometer may be integrated into the system such that it is at least movable about an axis and/or along an axis, whereby the pyrometer may be oriented differently for different measurements in order to measure the heat radiation from different measuring surfaces on the surface of the casting mold. The pyrometer may also be oriented such that it may measure the heat radiation from different measuring surfaces on the surface of different casting molds. The alignment of the pyrometer may, for example, be carried out by ease of a stepping motor. Alternatively, the pyrometer may also be aligned by ease of a servomotor. For example, hydraulic or pneumatic actuators may also be used for the alignment of the pyrometer. The at least one value of the determined temperature may, for example, be transmitted to a microcontroller which may control the inductive heating based on the specific temperature of the at least one measuring surface of the at least one casting mold. By ease of the microcontroller, on the one hand, it is possible to measure the heat radiation of at least one specific measuring surface and thereby to determine the temperature of the at least one specific area of the surface of the casting mold and to control the inductive heating based thereon. On the other hand, it is also possible to measure and combine the heat radiation of different measuring surfaces, and thereby to determine at least an average temperature from the various areas of the surface of the at least one casting mold and to control the inductive heating based thereon. According to the invention, the microcontroller may also provide instructions with which the at least one inductor may be controlled and with which, for example, the inductive heating may be interrupted and/or continued. In addition, the microcontroller may also provide instructions with which at least one lifting mechanism, by which the at least one inductor and/or the at least one casting mold and/or the at least one structural element is moved, may be set in motion. The person skilled in the art is aware that other means for determining a temperature may also be used. For example, the temperature of the at least one casting mold may also be determined by ease of temperature sensors within the at least one casting mold in which, for example, the electrical resistance is dependent on the temperature. The person skilled in the art is aware that the measurement of the temperature of the at least one casting mold, similar to the movement of the at least one lifting mechanism and/or the at least one structural element and/or the at least one inductor and/or the at least one casting mold, may be clocked. For example, the temperature of the at least one mold may be measured parallel to the inductive heating, i.e. during inductive heating, and the inductive heating may be directly controlled upon this. The person skilled in the art is also aware that the inductive heating of the at least one casting mold and the measurement of the temperature of the at least one casting mold may, for example, also be offset by a work cycle. For example, the means for measuring the temperature may be arranged such that it is stationary while the casting molds are moved past the means for measuring the temperature. In this case, the at least one casting mold may be heated inductively in a first work cycle, and after the clocking of the at least one structural element, the temperature of the at least one casting mold may be detected in a second work cycle. The detected temperature value may represent an actual value and the actual value may be compared with a desired value. From the difference between the actual value and the desired value, the inductive heating, which takes place in a subsequent work cycle of the at least one subsequent casting mold, may be controlled.

### BRIEF DESCRIPTION OF THE DRAWINGS

The invention is explained in more detail below with reference to exemplary embodiments with the accompanying drawings. Further details, features and advantages of the subject matter of the invention may result from the exemplary embodiments described. It shows:

FIG. 1 a vertical slice through an exemplary casting mold, permeated by an additive and surrounded by an inductor;

FIG. 2 the exemplary casting mold shown in FIG. 1 with inductor laying inside;

FIG. 3 a vertical slice through another exemplary casting mold permeated by an additive only in specific areas and surrounded by an inductor;

FIG. 4 a vertical slice through another exemplary casting mold permeated by an additive and with integrated inductor;

FIGS. 5a to 5e a vertical slice through multiple casting molds, which are clockwise heated inductively by an inductor.

### DETAILED DESCRIPTION

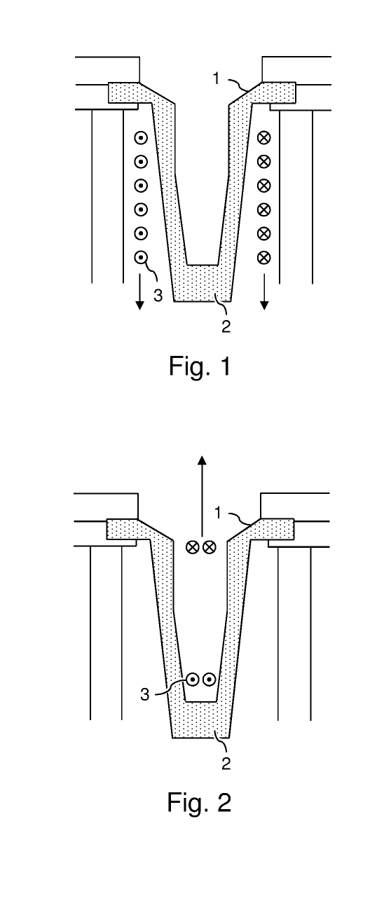

FIG. 1 shows schematically, by way of a vertical slice through a casting mold 1, the inductive heating of the casting mold 1 by ease of an inductor 3, wherein the casting mold 1 is permeated by an additive 2 which may be inductively heated.

The inductor 3 is a so-called internal field inductor, which may have the shape of a coil, which is also shown by ease of a vertical slice. The cross in the sectional area of the windings from the inductor 3 indicates that the current flows into the image plane and the point in the sectional area of the windings from the inductor 3 indicates that the current flows out of the image plane.

The highest magnetic flux density of the induced magnetic field occurs in the interior of the inductor 3 and the inductor 3 and the casting mold 1 are arranged during the inductive heating so that the surface of the casting mold 1 facing the inductor 3 is the outer surface of the casting mold 1. The inductor 3 and/or the casting mold 1 are moved relatively to one another for inductive heating by ease of at least one lifting mechanism (not shown) such that the surface of the casting mold 1 facing the inductor 3 is the outer surface of the casting mold 1. It may also be said that the casting mold 1 at least partly dips into the inductor 3. After the end of the inductive heating, the inductor 3 and/or the casting mold 1 are relatively moved again so that the inductor 3 and the casting mold 1 move away from each other. The relative movement of the inductor 3 and the casting mold 1 is represented by the arrows.

FIG. 2 shows a vertical slice through a casting mold 1, wherein the casting mold 1 is permeated by an additive 2, which may be heated inductively. In the exemplary embodiment shown, the inductor 3 is a so-called external field inductor. The highest magnetic flux density of the induced magnetic field occurs outside the inductor 3 and the inductor 3 and the casting mold 1 are arranged during inductive heating so that the surface of the casting mold 1 facing the inductor 3 is the inner surface of the casting mold 1. The inductor 3 and/or the casting mold 1 are moved relatively to one another for inductive heating by ease of at least one lifting mechanism (not shown) such that the surface of the casting mold 1 facing the inductor 3 is the inner surface of the casting mold 1. It may also be said that the inductor 3 at least partly dips into the casting mold 1. After the end of the inductive heating, the inductor 3 and/or the casting mold 1 are relatively moved again such that the inductor 3 and the casting mold 1 move away from each other. The relative movement of the inductor 3 and the casting mold 1 is represented by the arrow.

The shape and design of the inductor 3 is illustrated schematically and may deviate from the illustration. For example, the inductor 3 may also have the form of a surface coil. The use of the inductor 3 in the form of a surface coil in the inductive heating may, for example, produce a concentration of the induced magnetic field lines in certain regions, whereby the at least one casting mold 1 may selectively reach a high degree of inductive heating in certain regions. Other means are known to the person skilled in the art with which the use of the inductor 3 for inductive heating may be optimized. For example, the system with which the inductive heating is enabled, may additionally include at least one so-called pole piece (not shown) with which, for example, the course of the field lines of the alternating magnetic field induced by the inductor 3 may be homogenized in certain regions. This means that the magnetic flux density and the path of the magnetic field lines change only slightly in certain areas over a certain distance in their magnitude and in their course. As a result of the homogeneous course of the field lines of the induced alternating magnetic field, the at least one casting mold 1 may, in certain regions, undergo a homogeneous inductive heating.

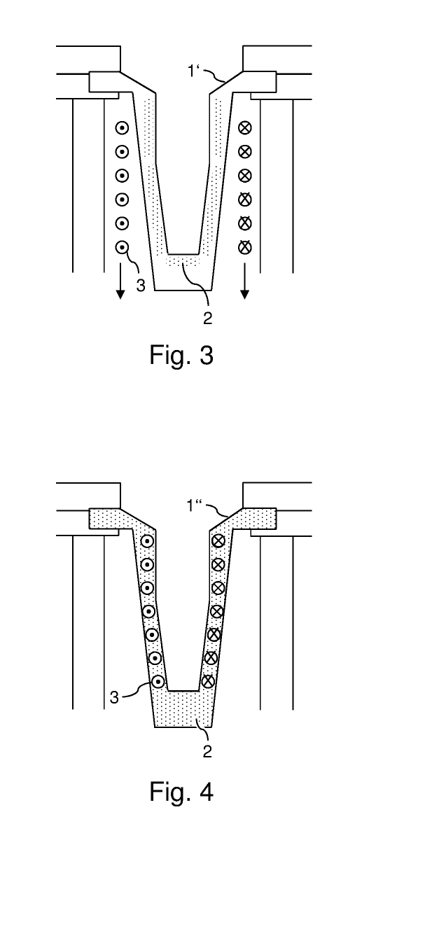

FIG. 3 schematically shows, by ease of a vertical slice through the casting mold 1′, the inductive heating of the casting mold 1′ by ease of an inductor 3, wherein the casting mold 1′ is permeated only in specific regions with an additive 2 which may be inductively heated. No inductive heating of the casting mold 1′ occurs in the regions of the casting mold 1′ in which the casting mold 1′ is not permeated with the additive 2, since the plastic material or the elastomer of which the casting mold 1′ according to the invention consists substantially, are not inductively heatable. In these regions, the casting mold 1′ is merely heated indirectly by heat transfer. By ease of the interspersion of the casting mold 1′ with the additive 2, which may be inductively heated, in certain regions of the casting mold 1′, the casting mold 1′ may be inductively heated in the specific regions by ease of the alternating magnetic field induced by the inductor 3. For example, the casting mold 1′ may be permeated with the additive 2 close to the inner surface of the casting mold 1′, thereby enabling a specifically inductive heating of the casting mold 1′ close to the inner surface of the casting mold 1′. For example, the casting mold 1′ may also be permeated with the additive 2 in different regions with a different concentration of the additive 2. The concentration of the additive 2, with which the casting mold 1′ is permeated, has an effect on the degree of inductive heating of the casting mold 1′. In high-concentration areas, a high degree of inductive heating of the casting mold 1′ occurs, and a small degree of inductive heating of the casting mold 1′ occurs in low-concentration areas. For example, the concentration of the additive 2 close to the inner surface of the casting mold 1′ may be high, whereby the degree of the inductive heating of the casting mold 1′ may be high near the inner surface of the casting mold 1′.

FIG. 4 schematically shows the inductive heating of the casting mold 1″ by ease of a vertical slice through the casting mold 1″. In this exemplary embodiment, the inductive heating of the casting mold 1″ occurs from the inside. The inductor 3 may be configured in such a way that it does not impair the flexibility of the casting mold 1″, which according to the invention consists substantially of a plastic material or elastomer. There, the inductor 3 and the material surrounding the inductor, that is, the inductively heatable additive 2, may be galvanically separated. For example, the galvanic separation may consist of a coating of the inductor 3. An advantage of the integrated inductor 3 opposite to the external inductors may be, for example, that the inductor 3 and the casting mold 1″ do not have to be moved relatively to one another before and after the inductive heating, and that, following the termination of the inductive heating, further process steps may be, for example, immediately executed in the production process of cosmetic products. This may, for example, reduce the cycle time.

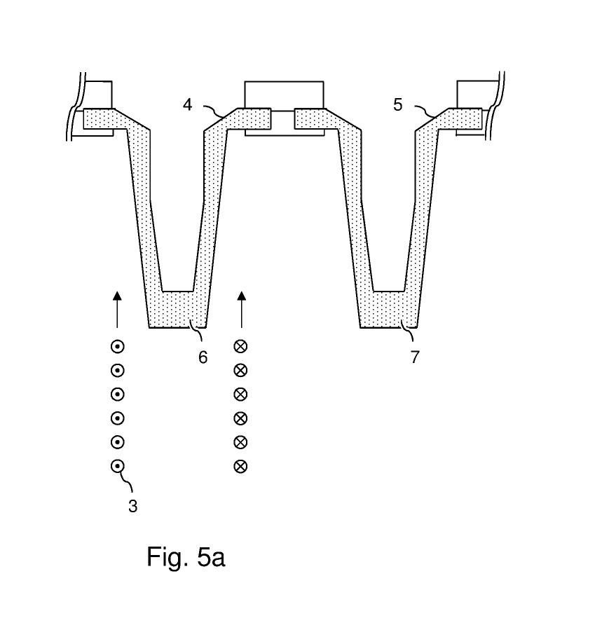

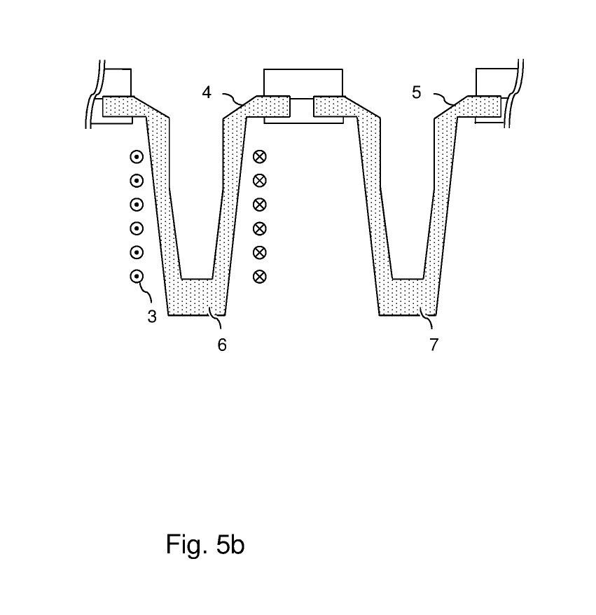

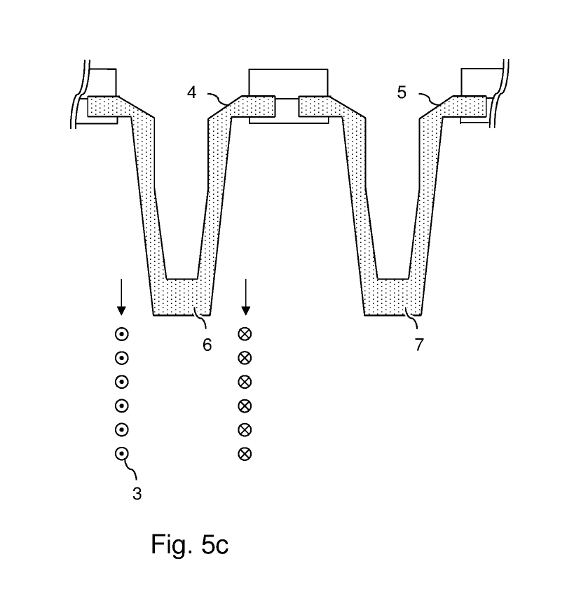

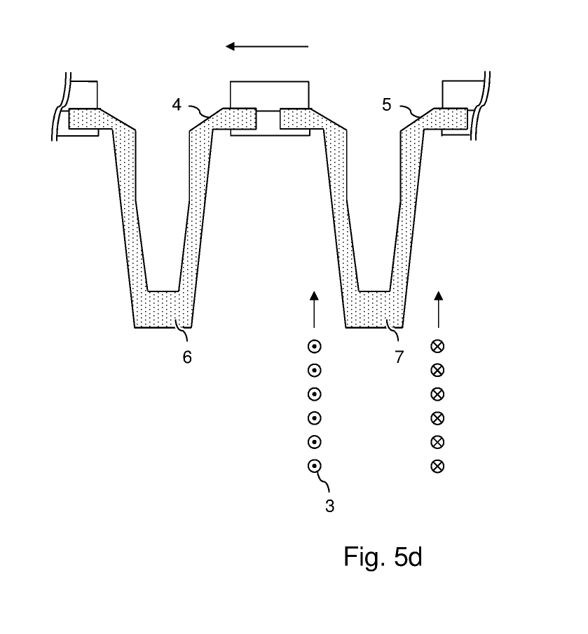

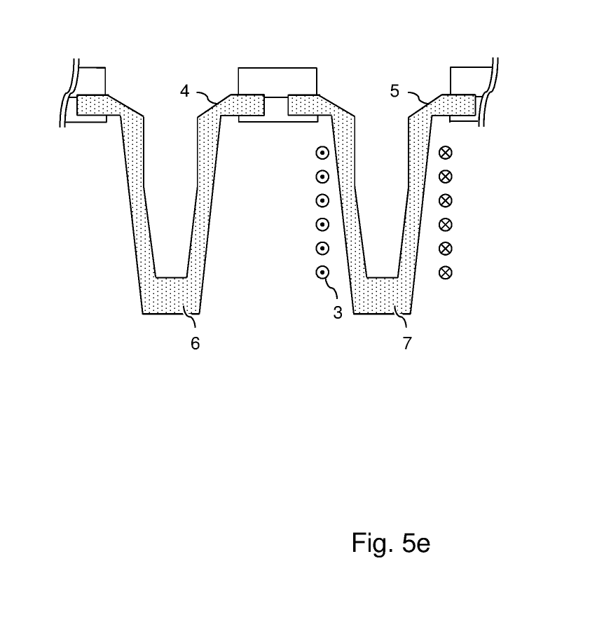

FIGS. 5a to 5e show schematically, by ease of a vertical slice through a plurality of casting molds 4, 5, the in-phase inductive heating of the casting molds 4, 5 by ease of an inductor 3, wherein the casting molds 4, 5 are permeated with at least one additive 6, 7, which can be inductively heated. The at least one additive 6, 7 may be the same additive. In the exemplary embodiments shown here, the casting molds 4, 5 are fastened to a structural element, wherein for example at least one first casting mold 4 and at least one second casting mold 5 may be attached to the structural element. That is, the structural element may carry the casting molds 4, 5. The movement of the casting molds 4, 5 is thus aligned by the movement of the structural element. It will be appreciated by those skilled in the art that the structural element may also carry further casting molds (not shown).

FIG. 5a shows schematically the beginning of a first time frame in a first work cycle, wherein the first casting mold 4 and the inductor 3 both are in a first position which may be referred to as starting positions of the first casting mold 4 and the inductor 3. The first casting mold 4 and the inductor 3 are then moved in a relative movement. In the illustrated embodiment, the inductor 3 is moved from its first position to the first casting mold 4 into a second position. The first casting mold 4 remains in its first position. The movement of the inductor 3 is represented by the vertical arrows in FIG. 5a. The second position of the inductor 3 is shown in FIG. 5b. The person skilled in the art is aware that the relative movement of the first casting mold 4 and the inductor 3 described herein may also take place by the inductor 3 remaining in its first position and the first casting mold 4 being moved to the inductor 3. The first casting mold 4 may also be attached to a structural element which performs the same relative movements as the first casting mold 4. The relative movement of the inductor 3 and the structural element may, for example, also be carried out by simultaneously moving the inductor 3 and the structural element. The first time frame of the first work cycle is completed when the second position of the inductor 3 is reached.

FIG. 5b schematically shows a second time frame in the first work cycle, wherein the inductor 3 is in the second position, in which the first casting mold 4 may be inductively heated by the inductor 3. The second time frame of the first work cycle is completed with the completion of the inductive heating. The end of the inductive heating by the inductor 3 may be indicated, for example, by a temperature sensor (not shown). In this case, the temperature sensor may emit a signal to a controller of the inductor 3, and the inductive heating may be controlled based on the signal. Subsequently, the first casting mold 4 and the inductor 3 are moved away from each other in a relative movement. In this case, the inductor 3 is moved from its second position—as shown in FIG. 5b—away from the first casting mold 4 into its first position—as shown in FIG. 5a. The first casting mold 4 remains in its first position. The person skilled in the art is aware that the relative movement of the first casting mold 4 and the inductor 3 described herein may also take place by the inductor 3 remaining in its position and the first casting mold 4 being moved away from the inductor 3.

FIG. 5c schematically shows the end of a third time frame in the first work cycle, wherein the inductor 3 moving back into its first position as shown in FIG. 5a. The movement of the inductor 3 is represented by the vertical arrows in FIG. 5c. The third time frame of the first work cycle is completed when the initial position is reached. With the completion of the third time frame of the first work cycle, the first work cycle is also completed. Subsequently, the first casting mold 4 and the inductor 3 may be moved in a further relative movement, which may also be referred to as further clocking.

The further clocking is represented by the horizontal arrow in FIG. 5d. In the exemplary embodiment shown here, the first casting mold 4 is moved from its first position into a second position, wherein the first casting mold 4 moves horizontally away from the inductor 3. The inductor 3 remains in its first position. Since the first casting mold 4 is fastened on a structural element to which at least a second casting mold 5 is attached, at least a second casting mold 5 is also moved when the first casting mold 4 moves by the movement of the structural element. When the first casting mold 4 is further clocked, the at least one second casting mold 5 is thus also further clocked. The further clocking may be completed, for example, when the at least one second casting mold 5 reaches a first position which corresponds to the first position of the first casting mold 4. Upon reaching the first position of the at least one second casting mold 5, a second work cycle may begin. The person skilled in the art is aware that the relative movement may also be carried out during the further clocking by moving the inductor 3 while the structural element and thus the first casting mold 4 and the at least one second casting mold 5 are not moved. The relative movement of the inductor 3 and the structural element during the further clocking may also be carried out, for example, by a simultaneous movement of the inductor 3 and the structural element.

Furthermore, FIG. 5d schematically shows the beginning of a first time frame in the second work cycle. In this case, the second casting mold 5 and the inductor 3 are both in a first position. The second casting mold 5 and the inductor 3 are then moved in a relative movement. In the illustrated embodiment, the inductor 3 is moved from its first position to the second casting mold 5 into a second position. The second casting mold 5 remains in its first position. The movement of the inductor 3 is represented by the vertical arrows in FIG. 5d. The second position of the inductor 3 is shown in FIG. 5e. The person skilled in the art is aware that the relative movement of the second casting mold 5 and the inductor 3 described herein may also occur in that the inductor 3 remains in its first position and the second casting mold 5 is moved to the inductor 3. The first time frame of the second work cycle is completed when the second position of the inductor 3 is reached.

FIG. 5e schematically shows a second time frame in the second work cycle, wherein the inductor 3 is in the second position, in which the second casting mold 5 may be inductively heated by the inductor 3.

It is clear that the work cycles as well as the time frames of the work cycles are the same, and that FIGS. 5a to 5e show, by way of example, a method for a clocked inductive heating of casting molds by ease of a plurality of casting molds, which can be clockwise inductively heated, such that this method may be implemented as a clock-controlled process in lipstick mine production.

It will be understood by the person skilled in the art that the exemplary embodiments shown are only exemplary and all elements, modules, components, participants and units shown may be differently designed, but nevertheless may fulfill the basic functionalities described here.

1. A method for heating a casting mold, in particular for heating a casting mold for cosmetic products, the method comprising:
generating of at least one alternating magnetic field using at least one inductor; and
inductive heating of at least one casting mold, wherein the at least one casting mold consists substantially of one plastic material or an elastomer and is permeated with at least one additive, wherein the at least one additive can be heated inductively.

2. The method of claim 1, further comprising:
regulating the at least one alternating magnetic field.

3. The method of claim 2, wherein an alternating current streams through the at least one inductor to generate the at least one alternating magnetic field and wherein the regulating the at least one alternating magnetic field comprises the regulating of the strength of the alternating magnetic field.

4. The method of claim 2, wherein an alternating current streams through the at least one inductor to generate the at least one alternating magnetic field and wherein the regulating the at least one alternating magnetic field comprises the regulating of the frequency of the alternating magnetic field.

5. The method of claim 1, further comprising:
adjusting the distance between the at least one inductor and the at least one casting mold.

6. The method of claims 1, further comprising:
determining a temperature of the at least one casting mold; and
controlling the inductive heating the at least one casting mold based on the determined temperature.

7. A casting mold, in particular a casting mold for molding cosmetic products, wherein the casting mold consists in particular of a plastic material or an elastomer and is permeated with at least one additive, wherein the additive can be inductive heated.

8. The casting mold of claim 7, wherein the plastic material is a plastic material from the group of thermoplastically processable elastomers, TPE, and the elastomer is an elastomer from the group of thermal vulcanized silicone rubber.

9. The casting mold of claim 7, wherein the at least one additive is an additive from the group of ferromagnetic materials and/or an alloy.

10. A system for heating of casting molds, in particular for heating of casting molds for cosmetic products, the system comprising:
at least one inductor for generating at least one alternating magnetic field; and
at least one casting mold, wherein the casting mold consists substantially of a plastic material or an elastomer and is permeated with at least one additive, wherein the additive may be inductively heated.

11. The system of claim 10, wherein the system further comprises:
a means for regulating the strength of the alternating current and/or for regulating of the frequency of the alternating current, which streams through the at least one inductor in order to generate the alternating magnetic field.

12. The system of claim 11, wherein the strength of the alternating magnetic field, which streams through the at least one inductor, is adjusted in the range from 50 A to 400 A and/or wherein the frequency of the alternating current, which streams through the inductor, is adjusted in the range of 50 Hz to 450 kHz.

13. The system of claim 10, further comprising:
a means for adjusting the distance between the at least one inductor and the at least one casting mold.

14. The system of claim 13, wherein the means for adjusting the distance is adapted to move the at least one inductor and/or the at least one casting mold.

15. The system of claim 10, further comprising:
a means for determining the temperature of the at least one casting mold; and
a means for controlling the at least one inductor based on the determined temperature.
